(19) United States
(12) Patent Application Publication
(10) Pub. No.: US 2024/0265472 A1
(43) Pub. Date: Aug. 8, 2024

(54) SOCIAL MEDIA SCORING SCHEMA CONNECTED TO CRYPTOGRAPHIC OBJECT SUBSET SELECTION

(71) Applicant: Emoji ID, LLC, Oakland, CA (US)

(72) Inventors: Naveen Kumar Jain, Nashville, TN (US); Robin Rath, St. Louis, MO (US); Simon Hill, Centennial, CO (US); Shradha Rao, London (GB)

(21) Appl. No.: 18/297,279

(22) Filed: Apr. 7, 2023

Related U.S. Application Data
(60) Provisional application No. 63/483,937, filed on Feb. 8, 2023.

(51) Int. Cl. G06Q 50/00

(52) U.S. Cl. CPC G06Q 50/01; G06Q 20/0658; G06Q 20/3672

(57) ABSTRACT

Disclosed herein is a social media platform profile implementation that makes use of web3 objects. Social media profiles generate wishlists of digital objects. Those wishlists enable newsfeed population, social discovery and playing of platform games. The wishlists are verified by smart contract elements that limit players to the game and the conduct of those players in the wishlist game.

### CROSS-REFERENCE TO RELATED APPLICATIONS

This application claims the benefit of U.S. Provisional Patent Application No. 63/483,937, filed Feb. 8, 2023. The aforementioned application is incorporated herein by reference in its entirety.

### TECHNICAL FIELD

The disclosure relates to social media profiles. The disclosure more specifically relates to games relating to use of web3 objects.

### BACKGROUND

Web 3.0 features enable tracing associations of digital objects on a distributed network over time. Metadata exists describing a timestamp that a given user obtains a particular digital object, how long they've held the digital object, and where that digital object came from. Social networking platforms do not make effective use of Web 3.0 features.

### BRIEF DESCRIPTION OF THE DRAWINGS

FIG. 1 is a block diagram illustrating a data structure of a smart contract.

FIG. 2 illustrates a block diagram of a system for using emoji sequence IDs for identifying wallet addresses of blockchain wallets.

FIG. 3 is a diagram illustrating a connection between digital objects and a distributed consensus network supported by a blockchain data structure.

FIGS. 4 and 5 are screenshots of implementations of 3D graphic objects where a given set of media data is applied to faces of the 3D graphic object.

FIG. 6 is a flowchart illustrating a method of social introduction based on web3 behavior.

FIG. 7 is a screenshot of a time-based leaderboard interface.

FIG. 8 is a flowchart illustrating a method of implementation of a time-based leaderboard interface.

FIG. 9 is a screenshot of multiple users occupying a matching leaderboard position.

FIG. 10 is a screenshot of a wishlist summary screen.

FIG. 11 is a screenshot of a wishlist game description.

FIG. 12 is a screenshot of is a wishlist builder.

FIG. 13 is a screenshot of a wishlist leaderboard.

FIG. 14 is a flowchart illustrating a schema associated with a wishlist game.

FIG. 15 is a block diagram of an exemplary computing system.

FIG. 16 is a block diagram illustrating an example machine learning (ML) system, in accordance with one or more embodiments.

### DETAILED DESCRIPTION

Disclosed herein are social elements and techniques to gamify web3 objects. In one such example, players identify a set of cryptographic objects (“a wishlist”) which are evaluated in one or more ways over a time locked period of time. One such way is the combined value thereof, though the calculation of the particular value is not necessarily objectively determined, thus a new method of evaluating those objects or collection thereof is disclosed herein. The cryptographic objects are unique but do belong to collections of similar objects. While a given unique object may not be for sale during the period of time of the game, the cheapest object from the collection that is for sale at the end of the period of time dictates a collection floor price, and that floor price serves as a value for purposes of the game. Other factors include objects held by each player, and time-based leaderboard features.

The behavior of owners of digital objects is to frequently trade their digital objects and cause significant turnover of those objects. The constant turnover of digital objects is not an ideal ecosystem for creators of said digital objects. Thus, it behooves such creators to make use of a gamified mechanic for digital objects that encourages holding on to those digital objects for extended periods. One such mechanic is a time-based leaderboard.

For a given set of digital objects, a leaderboard indicates how long a given user has held that digital object and ranking the users based on that length of time. In some embodiments, the leaderboard uses an absolute timeclock for a given digital object. In some cases, users will hold multiple digital objects from a given set of digital objects. Thus, in some embodiments, the leaderboard uses a timeclock connected to the length of time a given user contiguously holds a digital object from a given collection of digital objects (e.g., so long as a user holds one object from a given collection the clock continues to run).

In some embodiments, the leaderboard sorts ties based on number of digital objects from the collection held or based on staking of digital objects. When a digital object is “staked,” that object is transferred to a holding user for a predetermined length of time. Staking a digital object is akin to locking the object away in a vault for a period of time. While staked with the holding user, the original user cannot trade the digital object. While staking of a digital object technically transfers the digital object away from the original user, for purposes of the leaderboard, the digital object is considered contiguously controlled by the original user.

The leaderboard enables social benefits and loyalty rewards such as getting early or exclusive access to future distributions of digital objects and anything the creator wants to incentivize loyalty (a velocity sink) and award reputational benefits.

A possible extension of the game that would requires connecting a cryptographic wallet makes use of time-rank scoring. For example, to play a game, a player needs to own at least a threshold number of the collections (e.g., at least one cryptographic object per collection) on their Wishlist, with a minimum time rank. In other embodiments, the time rank provides bonus points or a multiplier based on how many collections on the player's Wishlist that they also own at the end of the game.

A specific example of an embodiment of the present invention relates to non-fungible cryptographic tokens (NFT). In some embodiments, the procedurally generated digital object is generated based on existing elements in a cryptographic wallet. A given cryptographic wallet has a number of NFTs present therein. The generator of digital objects interprets the various cryptographic protocols related to the NFTs present in the wallet, identifies content associated therewith, and procedurally generates a new NFT based on the existing ones present in the wallet.

Examples of uses of digital objects include as collectors items, tickets for events, identity information, art, and/or social networking or community building tokens.

### Cryptographic Platforms

Public and private keys are an integral component of cryptocurrencies built on blockchain networks and are part of a larger field of cryptography known as public-key cryptography (PKC) or asymmetric encryption. The goal of PKC is to easily transition from a first state (e.g., a private key) to a second state (e.g., a public key) while reversing the transition from the second state to the first state nearly impossible, and in the process, proving possession of a secret key without exposing that secret key. The product is subsequently a one-way mathematical function, which makes it ideal for validating the authenticity of transactions such as cryptocurrency transactions because possession of the first state such as the secret key cannot be forged. PKC relies on a two-key model, the public and private key.

The general purpose of PKC is to enable secure, private communication using digital signatures in a public channel that is susceptible to potentially malicious eavesdroppers. In the context of cryptographic tokens, the goal is to prove that a traded token was indeed signed by the owner of that token, and was not forged, all occurring over a public blockchain network between peers. A private key of a blockchain wallet unlocks the right for the blockchain wallet's owner to spend transfer tokens in the blockchain wallet and therefore must remain private. A wallet address of the blockchain wallet is cryptographically linked to the blockchain wallet's private key and is publicly available to all users to enable other users to send NFTs to the user's blockchain wallet. For example, the wallet address may be a public key generated from the blockchain wallet's private key using one or more PKC algorithms. Public keys are generally used to identify wallets, whereas the private keys are used to authorize actions of the respective wallet.

Wallet addresses for blockchain wallets are typically represented in human-legible form in one of three ways: as a hexadecimal representation, as a Base64 representation, or as a Base58 representation. In each of these common ways of representing the wallet addresses, each wallet address is represented using a string of letters and numbers, typically exceeding 20 characters in length. The length and randomness of the alphanumeric string makes the wallet address unwieldy and difficult to remember, thereby decreasing its usability and hindering the adoption of cryptocurrencies.

Structurally, in some embodiments, customized, flexible cryptographic tokens connected to a smart contract are powered by a less flexible, base cryptocurrency. Miners operating on the network for the base cryptocurrency power execution of a distributed application (dApp) or smart contract. The smart contract is held by an administrative user and includes all of the custom cryptographic tokens. The custom cryptographic tokens do not “move” in the same sense that the base cryptocurrency moves via transactions. The smart contract is “held” by the administrative user though secondary users may interact with the smart contract and various portions (specific tokens) may be attributed to those secondary users.

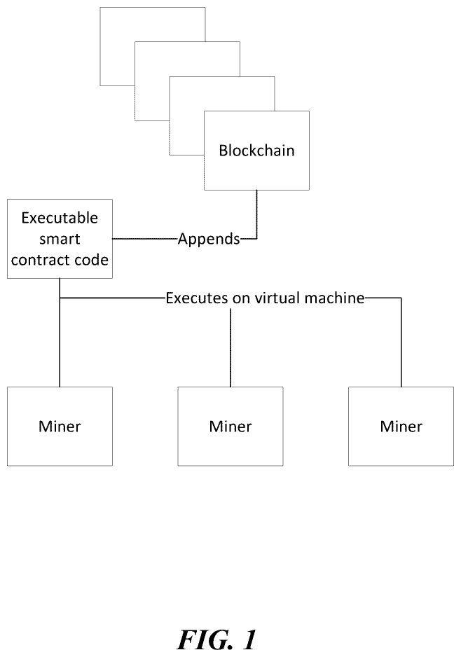

FIG. 1 is a block diagram illustrating a data structure of a smart contract. Smart contracts and dApps execute on an Ethereum virtual machine (“EVM”). The EVM is instantiated on available network nodes. Smart contracts and dApps are applications that execute; thus, the processing power to do so must come from hardware somewhere. Nodes must volunteer their processors to execute these operations based on the premise of being paid for the work in Ethereum coins, referred to as Ether, measured in “gas.” Gas is the name for a unit of work in the EVM. The price of gas can vary, often because the price of Ether varies, and is specified within the smart contract/dApp.

Every operation that can be performed by a transaction or contract on the Ethereum platform costs a certain number of gas, with operations that require more computational resources costing more gas than operations that require few computational resources. For example, at the time of writing, a multiplication instruction requires 5 gas, whereas an addition instruction requires 3 gas. Conversely, more complex instructions, such as a Keccak256 cryptographic hash requires 30 initial gas and 6 additional gas for every 256 bits of data hashed.

The purpose of gas is pay for the processing power of the network on execution of smart contracts at a reasonably steady rate. That there is a cost at all ensures that the work/processing being performed is useful and valuable to someone. Thus, the Ethereum strategy differs from a Bitcoin transaction fee, which is only dependent on the size in kilobytes of a transaction. As a result that Ethereum's gas costs are rooted in computations, even a short segment of code can result in a significant amount of processing performed. The use of gas further enforces incentivizes coders to generate efficient smart contracts/algorithms. Otherwise, the cost of execution may spiral out of control. Unrestricted, an exponential function may bankrupt a given user.

While operations in the EVM have a gas cost, gas has a “gas price” measured in ether. Transactions specify a given gas price in ether for each unit of gas. The fixing of price by transaction enables the market to decide the relationship between the price of ether and the cost of computing operations (as measured in gas). The total fee paid by a transaction is the gas used multiplied by gas price.

If a given transaction offers very little in terms of a gas price, that transaction will have low priority on the network. In some cases, the network miners may place a threshold on the gas price each is willing to execute/process for. If a given transaction is below that threshold for all miners, the process will never execute. Where a transaction does not include enough ether attached (e.g., because the transaction results in so much computational work that the gas costs exceed the attached ether) the used gas is still provided to the miners. When the gas runs out, the miner will stop processing the transaction, revert changes made, and append to the blockchain with a “failed transaction.” Failed transactions may occur because the miners do not directly evaluate smart contracts for efficiency. Miners will merely execute code with an appropriate gas price attached. Whether the code executes to completion or stalls out due to excessive computational complexity is of no matter to the miner.

Where a high gas price is attached to a transaction, the transaction will be given priority. Miners will process transactions in order of economic value. Priority on the Ethereum blockchain works similarly as with the Bitcoin blockchain. Where a user attaches more ether to a given transaction than necessary, the excess amount is refunded back to that user after the transaction is executed/processed. Miners only charge for the work that is performed. A useful analogy regarding gas costs and price is that the gas price is similar to an hourly wage for the miner, whereas the gas cost is like a timesheet of work performed.

A type of smart contract that exists on the Ethereum blockchain are ERC-20 tokens (Ethereum Request for Comment-20). ERC-20 is a technical specification for fungible utility tokens. ERC-20 defines a common list of rules for Ethereum tokens to follow within the larger Ethereum ecosystem, allowing developers to accurately predict interaction between tokens. These rules include how the tokens are transferred between addresses and how data within each token is accessed. ERC-20 provides a framework for a means to build a token on top of a base cryptocurrency. In some embodiments herein, enhancements are built on top of the ERC-20 framework, though use of the ERC-20 technical specification is not inherently necessary and is applicable to circumstances where Ethereum is used as the base cryptocurrency.

Another type of smart contract that exists on the Ethereum blockchain are ERC-721 tokens (Ethereum Request for Comment-721). ERC-721 is a technical specification for NFTs. The ERC-721 introduces a standard for NFT. An ERC-721 token is unique and can have different exclusivity to another token from the same smart contract, maybe due to age, rarity or visuals.

NFTs have a uint256 variable called tokenId. Thus, for any ERC-721 contract, the pair contract address, uint256 tokenId must be globally unique. That said, a given dApp can have a “converter” that uses the tokenId as input and outputs an image.

Disclosure on token protocols has focused on Ethereum. As applicable in this disclosure, Ethereum is a base cryptocurrency. Other base cryptocurrencies exist now and in the future. This disclosure is not limited to application on specifically the Bitcoin or Ethereum blockchains.

CryptoKitties is an early example of an NFT platform. Users would engage in breeding and trading of cryptographic tokens that were visually represented by cartoon cats. Each cat had a family tree that was tracked by a blockchain and went back to the originator cats that digitally sired the subsequent cats. The visual representation of each cat had an appearance dictated by a number of preset options and was at least partly controlled by the visual appearance of the parent cat tokens.

Users would mate and auction cats as a game mechanic. When two cats mated, a third cat would be generated by the CryptoKitties dApp. The third cat was visually represented by some amalgamation of the features of the parents with the potential of a mutation (to potentially gain a particularly rare feature neither of the parents exhibited). Ultimately, generation of a cryptokitty is based on the user input of existing kitties, and kitties are the only acceptable datatype. That is to say, no other types of NFT are applicable. One cannot mate a cryptokitty with an emoji ID.

CryptoKitties had a number of viral features that were indicative of exclusivity. These features included particularly rare combinations of visual features and a lineage that was relatively close to an originator cat. In both cases, there was no algorithmic benefit for either of these exclusivity features.

While CryptoKitties does not implement any algorithmic connection to exclusivity features, some embodiments of the present invention do. It is frequently the case that exclusivity features of NFTs are connected to originator or early generation tokens. Additionally, tokens having rare visual features are considered exclusive. What generation a given NFT is, is identifiable using either metadata on the token itself combined with thresholds or heuristics regarding generational definitions or is identifiable by tracing back the token's generation through the respective blockchain of that token. Rarity of visual features is identified via a survey of existing tokens and the existing visual features thereof. Thus, in embodiments of the instant invention an evaluation is performed on each relevant token used as input that identifies the exclusivity features of that token, then those features are captured for use in generation of a new unique procedurally generated digital object (e.g., an NFT).

### Emoji Sequence Based ID

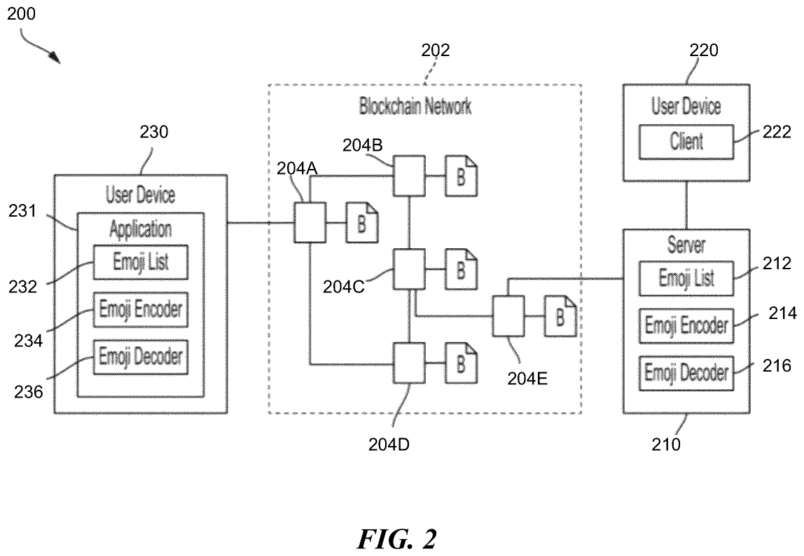

FIG. 2 illustrates a block diagram of a system 200 for using emoji sequence IDs for identifying wallet addresses of blockchain wallets. System 200 includes a blockchain network 202, user device 220, user device 230, and server 210.

As shown in FIG. 2, blockchain network 202 includes a plurality of nodes 204A-E (e.g., servers) that each maintain respective copies of a blockchain. In actual practice, blockchain network 202 may include hundreds or thousands of nodes. In some embodiments, blockchain network 202 may be a distributed peer-to-peer network as is known by those skilled in the art. In some embodiments, blockchain network 202 of nodes 204A-E implement known consensus algorithms to validate transactions submitted to blockchain network 202. A verified transaction may include transferred cryptocurrency, contracts, records, or other information to be recorded to the blockchain. In some embodiments, multiple transactions are combined together into a block of data that is verified across blockchain network 202. Once verified, this block of data can be added to an existing blockchain maintained by each of nodes 204A-E.

In some embodiments, a user can initiate transactions to be submitted to blockchain network 202 using user device 230. For example, the user may submit a transaction using application 231 configured to interact with blockchain network 202. For example, application 231 may generate and transmit cryptocurrency transactions to node 204A for validation and verification. Application 231 may include software downloaded from a digital distribution platform (e.g., App Store on Apple devices or Microsoft Store on Windows devices) or a content server. In some embodiments, application 231 provides a graphical user interface (GUI) that enables the user to generate transactions between his or her blockchain wallet and a blockchain wallet of a target recipient of cryptocurrency funds. Conventionally, the target recipient's blockchain wallet is identified by a wallet address in a human-legible textual representation. For example, the wallet address may be a string of numbers and/or characters such as in a hex format, a Base64 format, or a Base58 format. As described above, requiring the user to enter long strings of numbers and/or characters into application 231 to identify the wallet address of the target recipient is inefficient and prone to error.

In some embodiments, to enable the user to use an emoji sequence ID to uniquely identify a target wallet address for a blockchain wallet in cryptocurrency transactions, application 231 can implement an emoji list 232, an emoji encoder 234, and an emoji decoder 236.

In some embodiments, emoji list 232 can be stored in memory of application 231 and include a predetermined list of emojis that are used to enable use of emoji sequence IDs to identify wallet addresses of blockchain wallets. In some embodiments, the predetermined list includes a subset of emojis selected from the emojis in the Unicode Standard. For example, a give emoji list 232 includes 1626 emojis selected from the Unicode Standard. In some embodiments, 1626 emojis are selected because three emojis selected from 1626 emojis can uniquely map to a four-byte value. For example, an emoji ID of three emojis selected from 1626 emojis may include 1626^3 unique emoji IDs, which is less than 0.1% more unique values than the total possible number of unique values (i.e., 2^32) that can be represented by the four-byte (i.e., 32-bit) value. As will be understood by those skilled in the art, other numbers of emojis may be selected to be part of emoji list 232 to represent different number of bits. For example, an emoji list 232 having 46 emojis can represent an 11-bit value using two emojis (i.e., two emojis result in 46*46=2116 unique emoji IDs, which provides slightly more unique values than the possible values, 2048, of an 11-bit value).

In some embodiments, emojis in emoji list 232 may be selected to be visually dissimilar to reduce the likelihood that the user enters an incorrect emoji when entering the emoji sequence ID identifying the wallet address of the blockchain wallet. For example, the emojis may be selected such that no two emojis depict the slight variations of the same object. For example, a single emoji for a cat may be selected and included in emoji list 232 and not the multiple emojis depicting cats with different expression (e.g., grinning cat, cat with tears of joy, and pouting cat, etc.).

In some embodiments, to permit conversion between emoji IDs and integer values, emoji list 232 includes a plurality of emojis associated with a plurality of corresponding values. In some embodiments, emoji list 232 can be stored as an array, in which each emoji in the array has a corresponding index based on its position in the array. Therefore, each value associated with an emoji may be an index assigned to the emoji. In other embodiments, emoji list 232 may include a table that stores a plurality of emojis and that stores a plurality of values corresponding to the plurality of emojis. In these embodiments, emojis in emoji list 232 that are pictorially similar may be associated with the same value. In some embodiments, a set of emojis that is pictorially similar can include a plurality of emojis that depict types of the same object. For example, emoji list 232 may include multiple flag emojis that are each assigned an associated value of, for example, 9.

In some embodiments, application 231 can include an emoji mapping list that maps a larger number of emojis to the emojis in emoji list 232. For example, the emoji mapping list may include all available emojis in the Unicode Standard (i.e., 3,341 emojis as of January 2022). In some embodiments, by selecting mapping emojis to emojis in emoji list 232, two or more emojis that are pictorially similar may be mapped to the same emoji. For example, two or more emojis that show a clock depicting different types may be mapped to the same emoji of a clock. The use of an emoji mapping list may normalize the possible emojis to a list of emojis that are selected to be visually distinct to reduce error during user entry as well as to enhance the ease of visually verifying entered emoji sequence IDs.

In some embodiments, emoji encoder 234 can be configured to generate an emoji sequence ID that uniquely identifies a wallet address, which includes a predetermined number of bits (e.g., a 128-bit address or a 256-bit address). In other words, emoji encoder 234 can encode the wallet address into a sequence of emojis such that every wallet address is uniquely represented by exactly one sequence of emojis. Further, a valid emoji sequence ID represents exactly one wallet address. The encoding and decoding functions performed by emoji encoder 234 and emoji decoder 236, respectively, are symmetric functions. This means that encoding a wallet address, a, to its emoji sequence ID, s, and then applying the decoding function to emoji sequence ID, s, will always result in the originally encoded wallet address, a.

In some embodiments, to generate the emoji sequence ID, emoji encoder 234 can map a predetermined number of bits of the wallet address to a predetermined number of emojis selected from emoji list 232. In some embodiments, the predetermined number of bits of the wallet address can be divided into a plurality of non-overlapping groups of sequential bits. For example, the wallet address may be divided into 4-byte chunks. Then, emoji encoder 234 can convert each group of sequential bits into an emoji ID including a predetermined number of emojis based on emoji list 232. Finally, emoji encoder 234 can generate the emoji sequence ID identifying the wallet address by concatenating each emoji ID for each group of sequential bits into an emoji sequence.

In some embodiments, emoji encoder 234 can implement a mapping algorithm to convert the wallet address into the emoji sequence ID. For example, the mapping algorithm may include a BIP39 algorithm, an Electrum scheme algorithm, or a simple mapping from emoji index to a 10-bit value for emoji list 232 having at least 1024 emojis. In some embodiments, emoji encoder 234 can implement a mapping algorithm that uses indices of emojis in emoji list 232 to convert a numeric value to a predetermined number of emojis.

In some embodiments, to generate the emoji sequence ID, emoji encoder 234 may calculate a checksum value for the emoji sequence. For example, emoji encoder 234 may apply a checksum algorithm such as the Damm algorithm to calculate the checksum value. Then, emoji encoder 234 may convert the checksum value into an emoji representation including a predetermined number of emojis. Finally, emoji encoder 234 may output the emoji sequence ID identifying the wallet address by appending the emoji representation for the checksum to the emoji sequence previously calculated.

In some embodiments, emoji decoder 236 can be configured to generate a wallet address, which includes a predetermined number of bits (e.g., a 128-bit address or a 256-bit address), that is uniquely identified by an emoji sequence ID. In other words, emoji decoder 236 can decode the emoji sequence ID identifying the wallet address into a sequence of textual representations that uniquely corresponds to the wallet address. In some embodiments, the textual representation can correspond to an alphanumeric format for the wallet address that is required by blockchain network 202 to process cryptocurrency transactions. For example, the sequence of textual representations may be a hexadecimal string, a Base64 string, or a Base58 string.

In some embodiments, to generate the sequence of textual representations that identifies the wallet address, emoji decoder 236 can map the sequence of emojis in the emoji sequence ID to a numerical value identifying the wallet address based on emoji list 232. In some embodiments, emoji decoder 236 can determine the numerical value using emoji list 232 to identify a plurality of values corresponding to the plurality of emojis in the emoji sequence ID. For example, for an emoji in the emoji sequence ID, emoji decoder 236 may use an index of the emoji identified in emoji list 232 as a value associated with the emoji to be used in generating the numerical value. In some embodiments, emoji decoder 236 can convert a generated numerical value into the sequence of textual representations that uniquely identifies the wallet address.

In some embodiments, emoji decoder 236 can apply a checksum algorithm on the emoji sequence ID to determine whether the emoji sequence ID is valid. For example, emoji decoder 236 may apply the checksum algorithm to check whether the last emoji in the emoji sequence ID matches a result of the checksum algorithm applied to the emoji sequence ID excluding the last emoji. As described above with respect to emoji encoder 234, the last emoji may be generated to represent a checksum value of the emoji sequence ID. In some embodiments, if the checksum fails, emoji decoder 236 can halt processing because emoji sequence ID is invalid. In some embodiments, emoji decoder 236 can generate a notification indicating that the sequence ID is invalid.

In some embodiments, one or more emoji checksum can be extracted from the emoji sequence ID to generate a resultant emoji sequence. In some embodiments, the resultant emoji sequence can be divided into a plurality of non-overlapping groups of sequential emojis. For example, for an emoji list 232 having 1626 emojis, the result emoji sequence may be divided into groups of 3 emojis, with each group representing a 4-byte value. Then, emoji decoder 236 can convert each group of sequential emojis into a textual representation including a predetermined number of bits based on emoji list 232. Finally, emoji decoder 236 can generate the sequence of textual representations identifying the wallet address by concatenating each textual representation for each group of sequential emojis.

In some embodiments, functionality of application 231 may be performed elsewhere in system 200 such as on one or more of nodes 204A-E in blockchain network 202. In these embodiments, blockchain network 202 can be configured to be capable of processing transactions in which wallet addresses are identified using emoji sequence IDs. In some embodiment, an emoji sequence ID is a sequence of a plurality of emojis.

In some embodiments, functionality of application 231 may be performed elsewhere in system 200 such as on server 210. For example, server 210 includes emoji list 212, emoji encoder 214, and emoji decoder 216, which provides similar functionality as emoji list 232, emoji encoder 234, and emoji decoder 236, respectively. In some embodiments, server 210 may be a web server that enables users to operate a client 222 on user device 220 to access the functions of server 210. For example, client 222 may be a browser that enables the user to connect to a web portal or interface provided by server 210. Therefore, a user using user device 220 may initiate transactions to be verified by and added to blockchain network 202 via server 210.

### Blockchain Tracing of Digital Objects

Like Emoji sequences as described above, embodiments of the digital objects are encodable to a distributed consensus network such as a blockchain. An example blockchain is the Ethereum blockchain, via ERC-721 tokens. Whereas emoji sequences have a finite number of potential characters, the digital objects described herein do not. A theoretical encoding scheme is unable to scale indefinitely to match the number of characters/elements/formats that embody a given digital object.

A means to limit the number of variables to represent in a given digital object is to limit the number of digital objects in any given series or generation (e.g., 1000 digital objects). Where a series or generation is encoded to a portion of a cryptographic token, encoding may be refreshed and reused in subsequent series. For example, a first data unit (e.g., a byte) is used to identify the generation of the digital object whereas subsequent data units are used to encode the visual features of the digital object. The same encoding is subsequently used in a different generation to refer to a different visual feature.

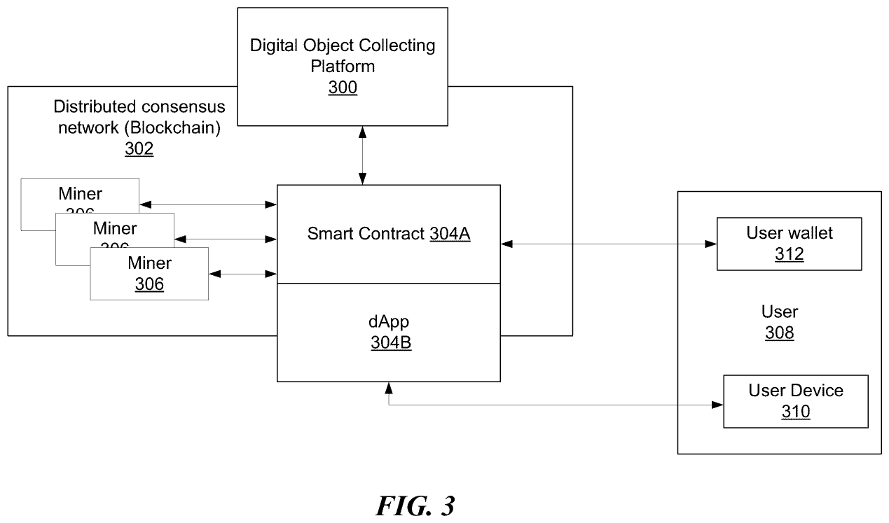

Generational divisions are also effectuated through event-based minting of digital objects. FIG. 3 is a diagram illustrating a connection between digital objects and a distributed consensus network supported by a blockchain data structure. A digital object creation platform 800 interfaces with a blockchain 302 via a dApp/smart contract 304A/B. The smart contract 304B is executed by miners 306.

When a user 308 requests minting of a new digital object via the dApp 304A, the dApp makes calls to other dApps connected with the user device 310 in order to identify other NFTs that the user has possession of via the other dApps. Embodiments of triggers to call other dApps include identifying other dApp software on the device 310 making the request to mint the new digital object, checking a list of popular dApps, and/or enabling the user to identify/flag (e.g., via GUI) which dApps they wish to flag for inspection for purposes of generating the new digital object.

In some embodiments, the dApp 304A ensures possession of the other NFTs used as input in the same user wallet 312 as the user wallet 312 associated with the initial request to generate the digital object. In this way, users are forced to actually own the NFTs that they are supplying as input for the generation of the digital object.

The check identifies the public key that is associated with both the requestor 308, and all of the user specific parameter/input. By nature of public keys being public information, no secret information need be shared with the dApp 304A.

Once minted, the dApp 304A delivers the new digital object as a cryptographic token/NFT to the cryptographic wallet 312 associated with the requesting user 308 via the smart contract 304A.

### Social Networking Platform

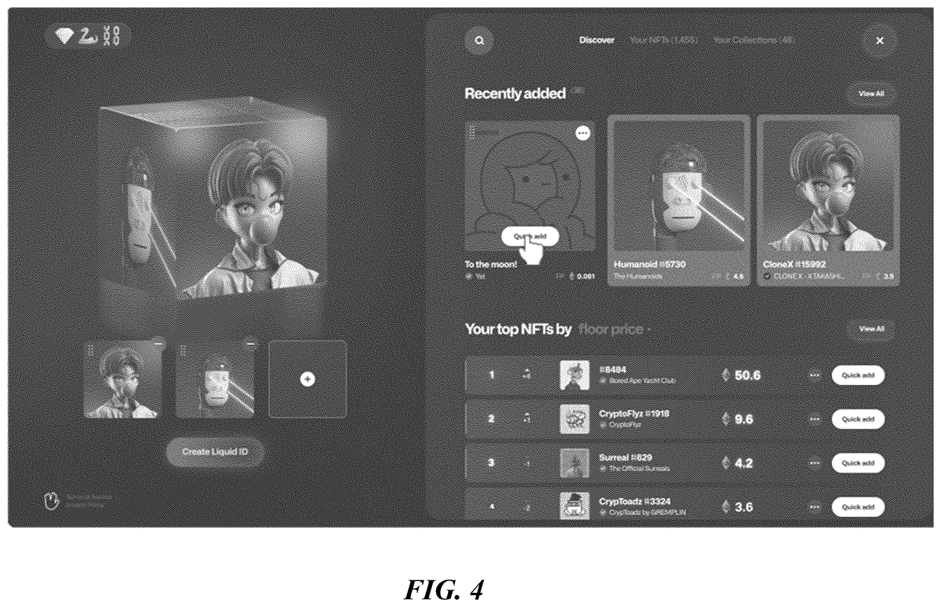

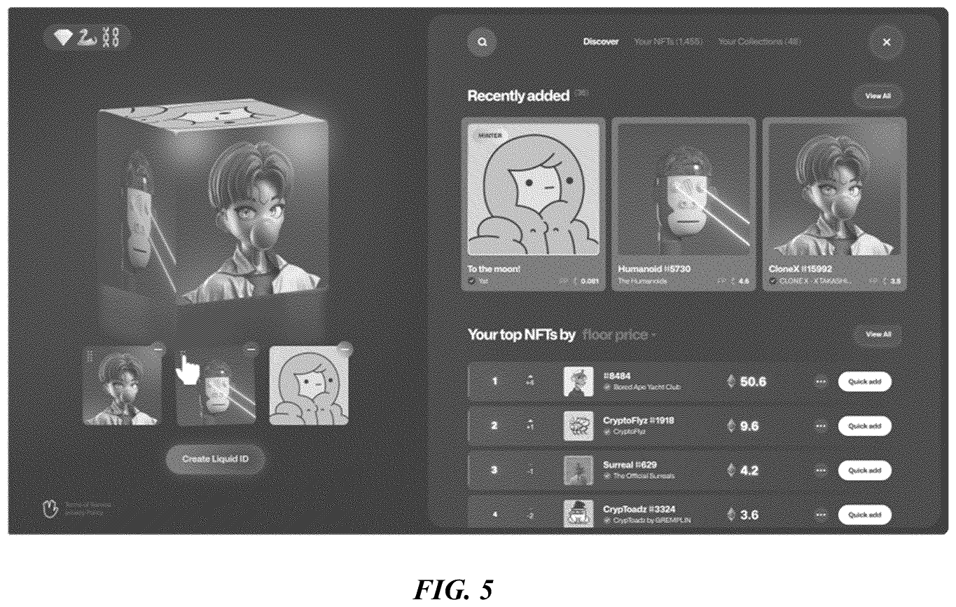

FIGS. 4 and 5 are screenshots of implementations of 3D graphic objects where a given set of media data is applied to faces of the 3D graphic object. One of ordinary skill in the art is able to ascertain embodiment and implementation details therefrom.

Additional social media features include indexed searches based on linked digital objects. Given a social media profile connected to a first user, indexed by an application server and searchable using a search function of an association social media platform, the user may link digital objects that enable search to identify the profile. Search for the social media profile is based on a query match to one or more predetermined fields of the social media profile, the one or more predetermined fields including a digital object field. Other fields include known details such as account name (real or otherwise), birthday, location, schools attended, employer, etc.

The digital object field refers to a digital object or token within the user's possession or previously in the user's possession. Where the digital object is a web3 object such as an NFT that is tracked on a blockchain data structure, on-chain history indicates both current ownership as well as previous ownership. When a given object is linked to a social media profile, that profile is searchable based on any recorded state of the digital object. For example, a search query may include a time threshold (e.g., possession within the last year, or possession within one week of object generation, etc. . . . )

The digital object as a cryptographic object stored on a distributed public ledger includes a human decipherable representation. The human decipherable representation includes any combination of an image description, a generation number, a serial number, or an associated dApp. Where the cryptographic object is an amalgamation of multiple cryptographic objects the human decipherable representation is subdivided by each of the multiple cryptographic objects. In the embodiments where multiple cryptographic objects are used, the search query may be constructed to target one of the multiple cryptographic objects or multiple cryptographic objects at the same time for greater specificity.

Cryptographic objects further include elements that are not generally human decipherable, such as the cryptographic identifier of the object. Other elements, such as chain of ownership and time of ownership do not have human decipherable records; however, through use of graphic interfaces and chain viewer applications, time of possession elements are presentable in a human decipherable manner.

In response to a search query including the human decipherable representation or a subset of the human decipherable representation of the cryptographic object, the application server return the sought social media profile or a set of social media profiles that match the search query (included the target profile).

Examples of a search queries include “all users with cryptokitties”, “all users who had a cryptokitty within 1 week of generation”, “all users who have a second generation cryptokitty” or “the user who presently holds the cryptokitty having serial number 12,345 in generation 0.”

In some embodiments, the social platform is directly linked to the user's cryptographic wallet and can therefore verify the authenticity of linkages between users and cryptographic objects. In some embodiments, the linkage to the wallet is via direct sharing of cryptographic keys that provides full access to the wallet. In some embodiments the linkage is proven via a zero-knowledge proof on performance of a zero-knowledge proof based on a digital wallet linked to the cryptographic object.

The zero-knowledge proof enables the owner of the cryptographic wallet demonstrate ownership of the wallet without revealing wallet credentials. The contents of the wallet are typically publicly observable, thus once the connection is established with the wallet, further evidence is not required to show ownership to the social network platform. Once a wallet is connected to the social network platform, the application server for the social network establishes listeners to monitor the wallet for changes to reflect on the social media profile of the user.

A Yat (an emoji sequence) is an example of a cryptographic object that a user may use to identify or index their profile. The emojis in the emoji sequence are individual characters that may be used to perform searches (either in specific order or not) for the social media profile.

### Social Discovery Based on Behavior

In some embodiments social discovery operates based on tracked web3 behavior. Web3 behavior are interactions on the Internet that are tracked on a blockchain as associated with a cryptographic address. The web3 behavior is observed and tracked using one or more block explorer programs. Block explorers are an online blockchain browser that show the details of all transactions that have ever happened on a given blockchain network. Some block explorers can be used on multiple different networks, while others are only for one specific blockchain. A BTC block explorer, for example, would only be able to find information from the Bitcoin network, such as when someone is sending Bitcoin to another wallet. A block explorer can be used to find any specific transaction or view the recent history of the chain more generally.

Examples of tracked behavior include acquisition of cryptographic tokens and cryptographic coins, tracking hold time for tokens, and tracking acquired cryptographic tokens relative to other cryptographic tokens in similar groups (e.g., associated with the same smart contract, same token drop, same generation of tokens, etc.). In a given profile, a user obtains a first cryptographic token from a particular drop at a cost at a certain percentage of the average for similar cryptographic tokens from the same drop, then holds that cryptographic token for 12 months. That example behavior is replicated many times over for each cryptographic object the user's profile is associated with.

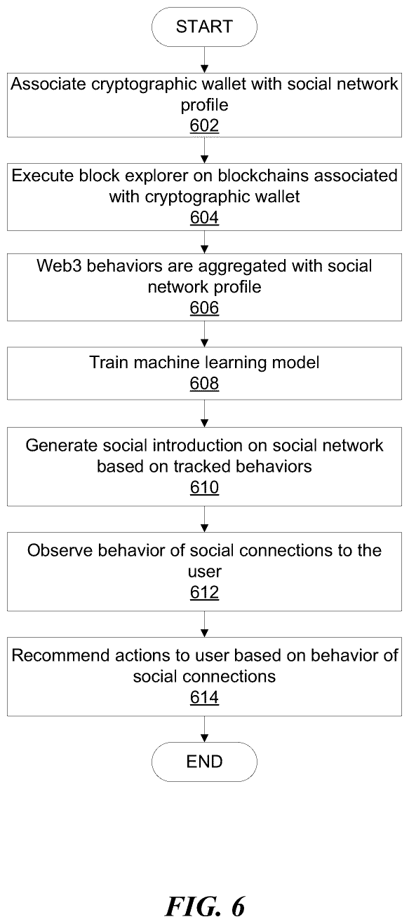

FIG. 6 is a flowchart illustrating a method of social introduction based on web3 behavior. In step 602, a user associates one or more cryptographic wallets with a given social network profile. In step 604, a block explorer is applied to each of relevant blockchains associated with activity by the one or more cryptographic wallets. In step 606, the web3 behavior observed by the block explorers is aggregated and associated with the given social network profile.

In step 608, the raw data from the block explorer(s) across a large plurality of users is used to train a machine learning model as training data. Across a plurality of users the aggregated behavior enables categorization profiles of users based on the web3 behavior. In some embodiments, the machine learning model is a CNN, a hidden Markov model, or a heuristic model.

In some embodiments, the model generates a glossary of behaviors. The glossary of behaviors is a combination of activity that together is categorized into classes. Having performed a given category of behavior informs the model of a propensity to conduct that class of behavior by that user. Examples of behavior categories are collecting one or more web3 objects from a particular group of objects, collecting a combination of web3 objects from a set of particular groups of objects, collecting a web3 object at a particular price point relative to others in a similar group, holding a web3 object or set of web3 objects a threshold amount of time, or collecting a web3 object within a threshold amount of time from availability of that web3 object.

In some embodiments, a conviction graph is used as an analog for user behavior. A conviction graph is described in further detail below. A conviction graph results in a score or multiple scores per group of web3 objects.

In step 610, the a given user is introduced via the social network to other users who have similar behavior profiles as indicated by the machine learning model. Introduction in the social network often takes the form of recommended friends or social connections. In some embodiments of an introduction, a given element of web3 behavior may be used to explain to the user why the introduction is being made. For example, two users who both obtained a particular cryptographic token from the same set of tokens at a similar price point and at a similar time are suggested to one another as social connections by the model, and that particular token acquisition is reported to each user as a justification for the social discovery action.

Where a conviction graph is used as an analog to a behavior profile, the scores are compared to indicate conviction in a given set of web3 objects. Users with similar levels (e.g., within a threshold score) of “conviction” are introduced via social discovery on the social network. In some embodiments, sub-scores are used for various elements of the conviction graph, and the sub-scores are used for more granular matching in social discovery.

In step 612, the social network observes activity by social connections of a given user (introduced via the model, or any other means of social connection) and recommends particular web3 behavior of those social connections to the given user. In some embodiments, the recommended behavior is based on consistency with the web3 behavior profile of the given user as built by the machine learning model. Examples of given recommended behavior is copy trading for tokens (contemporaneously) or “sweeping the floor” of a given set of tokens (i.e., obtaining the cheapest tokens in a particular set of tokens). Another example of recommended behavior is collection matching. That is, where a user with a similar behavior profile has a specific set of tokens from various tokens drops, a recommended collection matching behavior is to obtain tokens from similar drops until the specific set is matched on both users.

Another example of recommended web3 behavior is asynchronous holding. Two users obtain similar tokens asynchronously, and a first of those users trades theirs away after a set period of holding. After the second user has held the token a matching period of time, the model recommends trading the token away.

In step 614, whether the given user acts on the recommended behavior is submitted to the model to update the user's profile and used to further train the model as a whole.

Social discovery elements function both on a one-to-one basis (e.g., user to user), on a one-to-many basis (e.g., user to group), or on a many-to-many basis (e.g., group to group). The social discovery elements enable not just introduction but competition between users or groups thereof. Competition is illustrated by leaderboards, for example, leaderboards with respect to a given set of web3 objects.

### Time-Based Leaderboard

The behavior of owners of NFTs is to frequently trade their digital objects and cause significant turnover of those objects. The constant turnover of digital objects is not an ideal ecosystem for administrators or artists related to those NFTs. The time-based leaderboard thus encourages users and holders of NFTs to hold their NFTs longer.

The leaderboard indicates how long a given user has held a given NFT for example from a particular collection/generation of NFTs. A collection may be defined as a particular drop, from one smart contract/dApp, or as the entirety of the NFTs within a given smart contract. In some embodiments, the time-based leaderboard is based off NFTs from a contemporaneous collection so as to compare fairly. In such circumstances, all users who have continuously held their NFTs from that collection will be tied for first.

Thus, sorting ties is an important detail for purposes of the leaderboard. In some embodiments, ties are sorted by a number of digital objects from the collection held or based on staking of digital objects. When a NFT is “staked,” that NFT is transferred to a holding wallet/contract for a predetermined length of time. Staking an NFT locks that NFT from transfer by the owner. While staking of a NFT technically transfers the NFT away from the owner's wallet, for purposes of the leaderboard, the NFT is considered contiguously owned by the original user.

The leaderboard enables social benefits and loyalty rewards such as getting early or exclusive access to future distributions of NFTs and anything the creator wants to incentivize loyalty (a velocity sink) and award reputational benefits.

Identity on the leaderboard is displayed in a number of ways. Additional information provided to the leaderboard enables additional manners of representing an identity on the leaderboard. At a base level, a cryptographic address associated with a wallet that holds an NFT serves as a functional identity for users on the leaderboard. However, when available (e.g., tied to a given cryptographic address), the leaderboard is enabled to use a 3D graphic object (described above) as a rotating or cycling representation of a user's identity. Other examples of identity include social network handles, Yats, user names, and/or real names.

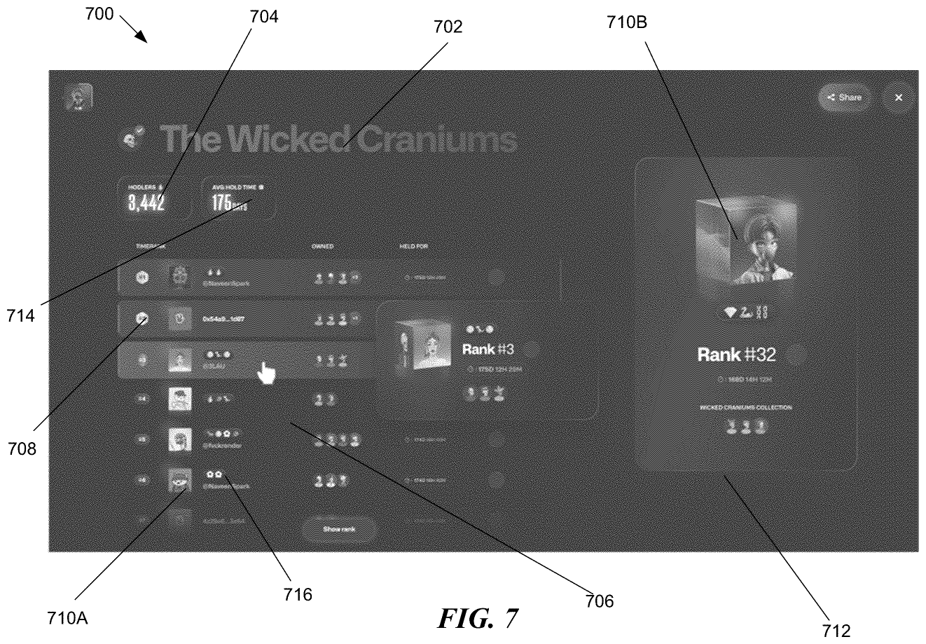

FIG. 7 is a screenshot of a time-based leaderboard interface 700. The leaderboard 700 pertains to a particular collection 702 of digital objects/NFTs. As depicted in the Figure, the collection 702 is “The Wicked Craniums,” a set of procedurally generated art of skeleton characters based on artist created visual assets. The leaderboard 700 further includes a counter 704 for the number of users who have an NFT from the collection 702. The leaderboard 700 is embodied by a chart of ranks 706 which orders the users based on the contiguous length of time they have possessed an NFT from the collection 702.

The chart of ranks 706 displays the numerical ranks 708 of each user and an identity 710 for each user. In the chart of ranks 706, the user's identity 710 is displayed using a 2D representation 710A of an identity digital object (described above). The media displayed by the user identity 710A is either of a cycling/rotating media data or a predetermined “front face” of the identity digital object.

To the right side of the screen, an active user's profile 712 is depicted. An identity digital object is further depicted in 3D 710B, with faces each having media content as described above. The leaderboard further includes an average length of possession of NFTs 714. Further linked to the users are Yats 716. In this depiction, a Yat 716 is another NFT type that is linked to the identity digital object, on a one-to-one basis. However, in some embodiments, linking of NFT types is performed on a many-to-one or many-to-many basis.

The data underlying the leaderboard is available in cryptographic records on a relevant blockchain as associated with the smart contract linked to the collection 702. In some embodiments, while the leaderboard itself is public, the underlying data is gated behind collection controls. For example, the artist that administrations the collection 702 has access to the underlying data in a sorted format. The underlying data is used to implement leaderboard rewards such as early or exclusive access to subsequent collections. Because access is based on connection to a valid public cryptographic address, the underlying data identifying users based on the public cryptographic addresses is useful for issuing leaderboard rewards.

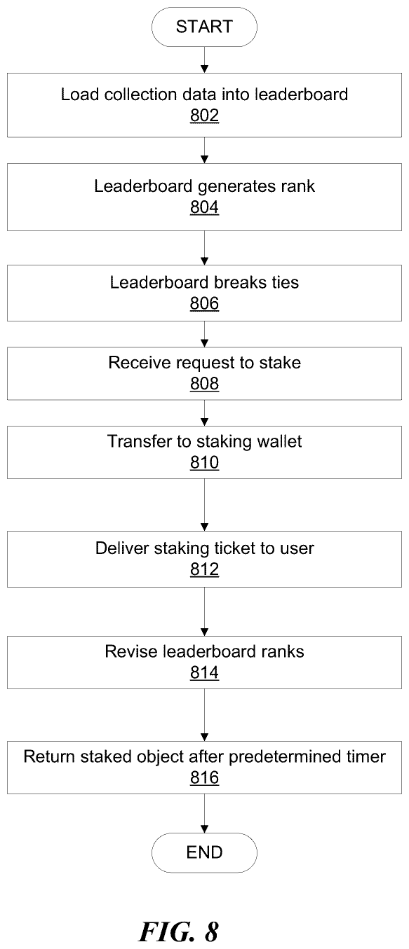

FIG. 8 is a flowchart illustrating a method of implementation of a time-based leaderboard interface. In step 802, a leaderboard platform loads a set of digital object collection data. In step 804, the leaderboard platform generates a rank order based on length of possession for digital objects in the collection by user.

In step 806, the leaderboard breaks ties. Ties are broken by number of digital objects held and/or length of object staking. In step 808, the leaderboard platform receives a request to stake a digital object for a predetermined period of time.

In response to the request to stake the digital object, in step 810, the digital object is transferred to a universal staking wallet where the digital object is locked and prevented from interaction for the predetermined time. Staked digital objects protocol limited digital objects that indicate a future of holding the digital object. Staking demonstrates greater than an intent to hold, as there is no way to return a staked digital object before the predetermined time expires. In some embodiments, there are separate leaderboards for length of stakes (e.g., divorced from past holding time).

In step 812, the universal wallet provides the owner with a staking ticket digital object that tracks the staked digital object. In some embodiments the staking ticket enables return of the staked digital object to cryptographic address other than the address the digital object had been in. The staking ticket includes identity information such that the owner may be identified separate from the original cryptographic address. For example, in some embodiments, the staking ticket includes encrypted data that is verified via zero-knowledge proof. Verification via the zero-knowledge proof enables the user to redirect the return of the digital object after the staking period has ended.

In embodiments where the identity digital object includes digital objects represented on faces, such as on a 3D object, the platform that generates the identity digital object and connects the content of cryptographic wallets to those faces is enabled to use digital objects that are staked despite those staked objects not being present in the linked wallets. The connection of the staked object to the identity digital object is made through the smart contract that stakes digital objects and/or the staking ticket object. In effect, the owner of the digital object still retains the display benefits of the digital object, but does not retain the ability to trade/transfer/sell said digital object.

In step 814, the leaderboard revises ranks based on the stake. Stakes objects may be re-staked for longer periods by their users. Re-staking enables users to “one-up” other users on the leaderboard.

In step 816, after the predetermined staking period ends, the digital object is returned to the original owner of the digital object. In some embodiments, the return is automatic to the original wallet that the digital object was transferred from. However, it is sometimes the case that wallets are compromised, and thus the staking ticket enables users of compromised wallets to indicate return to some other wallet.

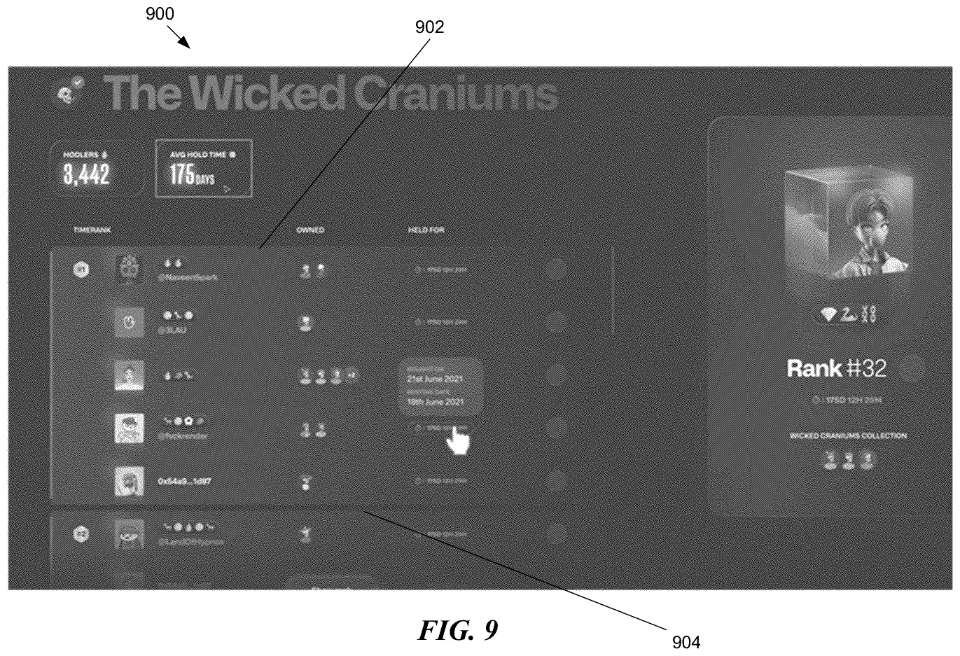

FIG. 9 is a screenshot of multiple users occupying a matching leaderboard position. The leaderboard 900 illustrates five users tied for first place 902 and some undetermined number of users tied for second place 904. In some embodiments, ties on the leaderboard are permitted.

### Conviction Graph

A conviction graph is an objective, machine generated analog for a user's interest in a set of web3 objects. In prior art social media platforms, user interaction has no cost to the user. “liking” a post or joining a group is performed at a click. The conviction graph illustrates the principle that “actions speak louder than words” by creating an objective, machine evaluable measure.

Using a block explorer on a given cryptographic address (or multiple addresses) linked to a social media profile, a block explorer identifies a number of factors regarding the web3 holdings of the user of the social media profile (or multiple social media profiles). A first factor is regarding early acting—that is, did the user mint the given web3 object being evaluated? A higher score is granted for those who minted the web3 objects and increases for each object minted. In some embodiments, a reduced score (relatively) is available for those who obtained their web3 objects shortly after minting. The value of the early acting factor reduces quickly (e.g., exponentially) the longer from minting a given object came into possession of the user.

A second factor pertains to time-based, or time-rank for holding length. Users whom have held their web3 objects longer (or staked to hold for longer) receive higher scores. The scores are increased by the number of objects held for the given duration. The time-based evaluation is described above.

A third factor is overall number possesses and/or the financial exposure of those web3 objects held (present day). The third sub-score is thus based on how many web3 objects of the set the user is currently holding. In some embodiments, the score is enhanced by the value of those objects (e.g., in cryptocurrency or fiat). In some embodiments, the value of the web3 objects acts as a fourth, separate factor. Value or monetary exposure is based on current value despite that when a given user obtains their web3 objects greatly effects the actual financial exposure of that user.

Each factor is evaluated on a per set of web3 object basis. A set of web3 objects is delineated in a number of ways. For example, each web3 object belonging to a given class of objects as defined by the smart contract each is connected to, each web3 object in a given generation or drop of objects, or each web3 object connected to the same artist or programmer.

In some embodiments, the score and/or sub-scores pertaining to a given set of web3 objects is weighted by the overall value that asset has compared to overall holdings by that user (or group of users). Thus, sets of web3 objects that are outsize assets or otherwise significant portions of overall holdings are weighted more heavily. In some embodiments, the weighting factor compensates for users with vastly different purchasing power. That said, the weighting factor should not compensate to a degree such that a user with a single web3 object (i.e., their entire holdings) is weighted to match someone with hundred of web3 objects. Thus, brand new users or users with little to no platform usage are not matched with “power users.”

In some embodiments, the overall score on the conviction graph is a multidimensional data structure. In other embodiments, the overall score is a single value. In some embodiments, sub-scores connected to the various factors above are compared against the corresponding sub-scores of other users to enable more granular comparisons.

The conviction graph enables objective evaluations that are not inherently possible by humans alone that even with the aid of a block explorer are unable to generate the multi-dimensional space used to evaluate matches between users or groups thereof.

### Wishlist Game

The wishlist game is a social network game whereby users hope to identify popular cryptographic objects within a period of time. The wishlist game includes a number of variants regarding evaluating the outcome of the game and restrictions used to define valid wishlists.

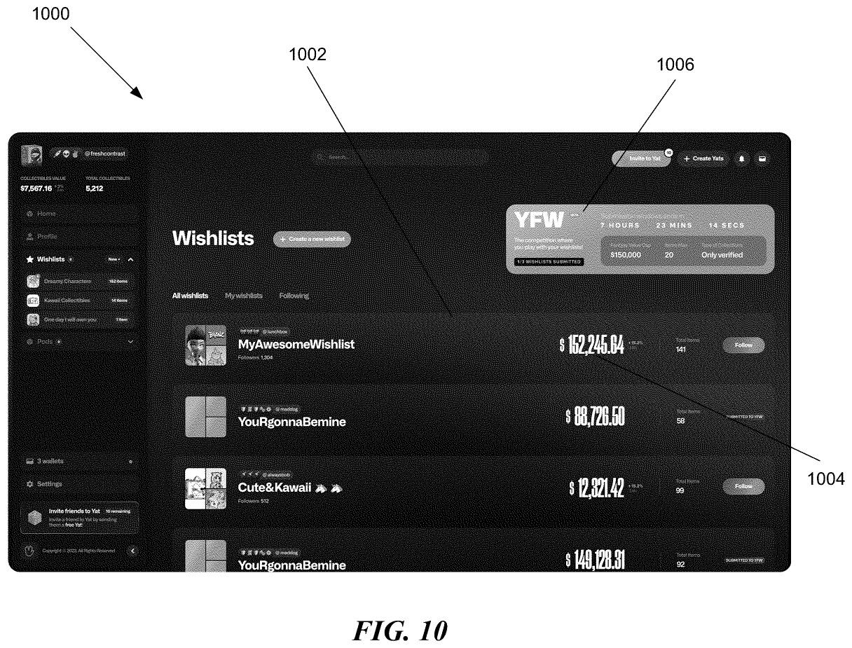

FIG. 10 is a screenshot of a wishlist summary screen 1000. The summary screen 1000 includes a set of wishlists 1002 assembled by the user and associated with their social network user profile. Each wishlist includes a set of cryptographic objects selected by the user. The social network enables users to follow wishlists made by various users and have modifications to those wishlists appear in newsfeeds and/or or the content of those wishlists influence newsfeed elements for the following users.

The wishlists include “a present value” 1004. The present value 1004 follows objective guidelines but is not necessarily an accurate assessment of the exact market value of the cryptographic objects on the wishlist. Specifically, cryptographic objects, such as NFTs are unique, and are frequently not for sale. For example, high time ranked NFTs or otherwise staked NFTs that cannot be traded have no recent sale data and/or cannot be sold. Value is otherwise assigned by a floor price of the collection or sub-group. The floor price is the lowest price for NFTs within the same collection. As the cheapest available NFTs of the same collection are purchased and removed from the market, the floor prices raise. In some embodiments, the floor price is superseded when the individual NFT on the wishlist is listed for sale for a higher value. In some embodiments, the floor price is superseded when the individual NFT on the wishlist has sold for a different value within a threshold period of time.

The summary page 1000 further includes a wishlist game link 1006 that indicates parameters for a current or upcoming game. In some embodiments, the wishlist game is governed by a smart contract. The smart contract embodiment enables external parties to generate wishlist games. For example, the social network itself need not generate or manage the wishlist game. The social network merely accesses the smart contract and provides a user interface platform to the smart contract.

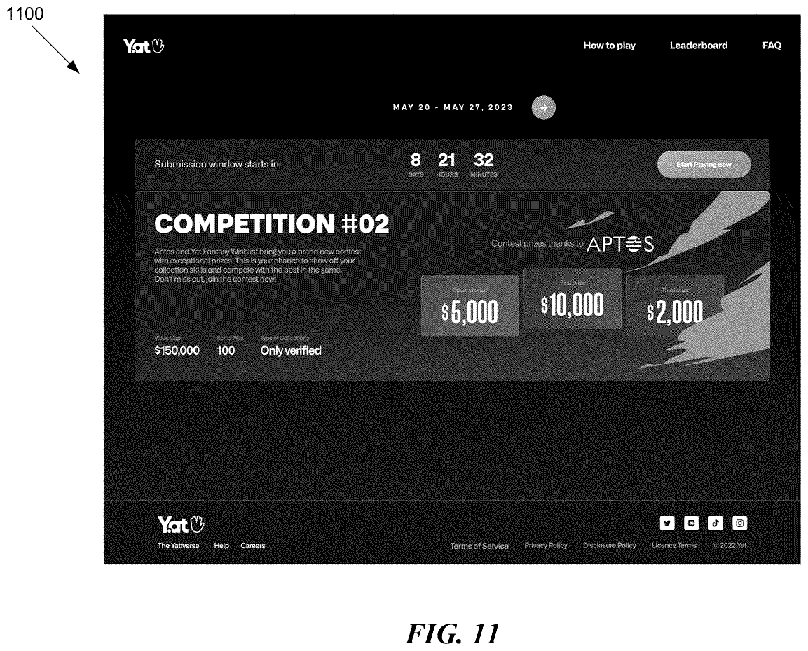

FIG. 11 is a screenshot of a wishlist game description 1100. The particular depicted wishlist game has a maximum cap on entry value, a maximum number of NFTs that may be present on the wishlist, indicates when the window for wishlist submission opens, indicates that the game length is one week, and indicates prizes from a sponsor. Notably, the wishlists in the depicted game are required to be verified. In some embodiments, verified wishlists require the user to own a member of at least a threshold number of the collections on their wishlist. In some embodiments, verified wishlists require the user to have a minimum time rank position in a given collection to select NFTs from that collection. Verification is performed via the wishlist game smart contract that checks connected wallets to the user's social network profile.

The wishlist game ultimately evaluates the total value or the total percentage increase of the wishlist at the end of the game period and the greatest value and/or the greatest increase is the victor of the game. The wishlist enables a contest that offers real awards to whoever wins. In some embodiments, the players have an entry stake—entering the contest requires players to stake digital assets (crypto and/or NFTs) and also allows players to stake the contest prize (with digital assets). The game itself is facilitated as an on-chain, decentralized game with risk/potential reward for all participants.

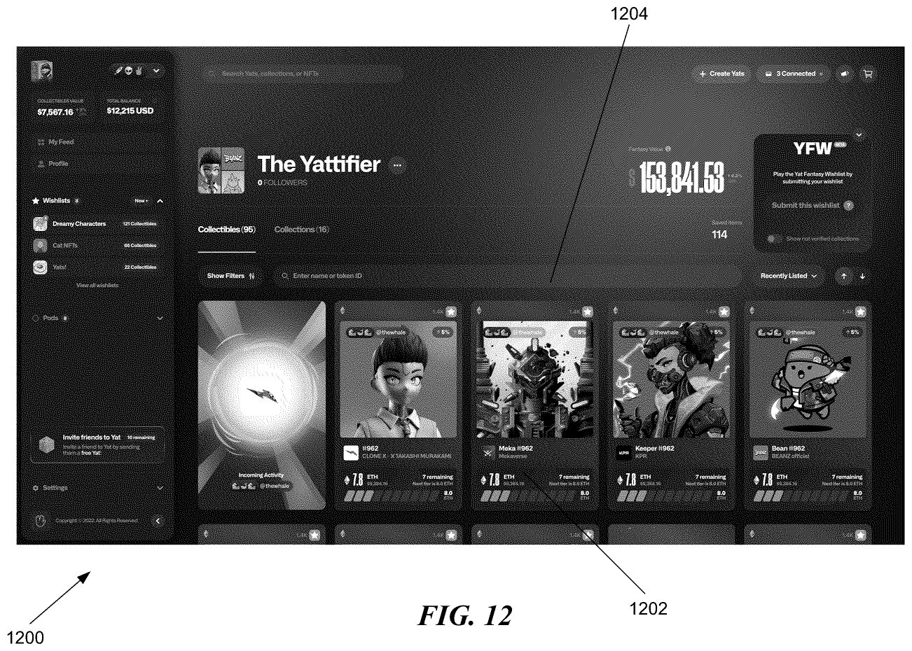

FIG. 12 is a screenshot of is a wishlist builder 1200. The wishlist builder 1200 includes a visual summary 1202 of selected NFTs. The wishlist builder 1200 further includes a search bar 1204 that enables a user to search collections and individual NFTs on those collections to add to their wishlist.

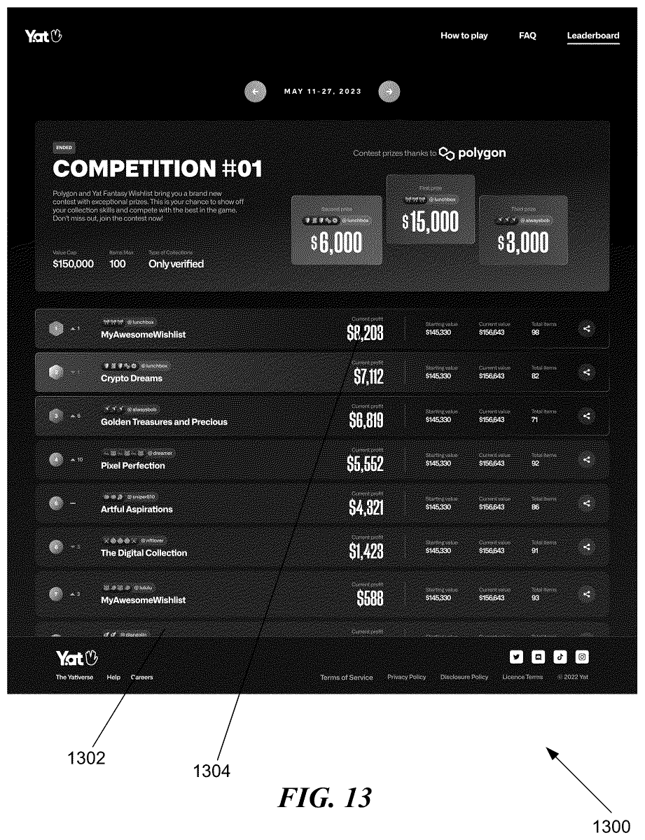

FIG. 13 is a screenshot of a wishlist leaderboard 1300 in a graphical webpage presentation. The leaderboard 1300 indicates a current status or winner of a current wishlist game including a set of users 1302 and the individual score increase 1304 for each player. At the end of the game, winners are awarded prizes based on the smart contract that facilitates the game. During the game, the leaderboard live updates periodically. The platform performs scraping of either of blockchain data structures upon which the digital objects reside, or web databases such as NFT marketplaces (e.g., Open Sea, Rarible, Binance, NBA Top Shot, etc. . . . ). Scraping identifies data that is relevant to selected collections/sub-groups and identifies a floor for each of those collections.

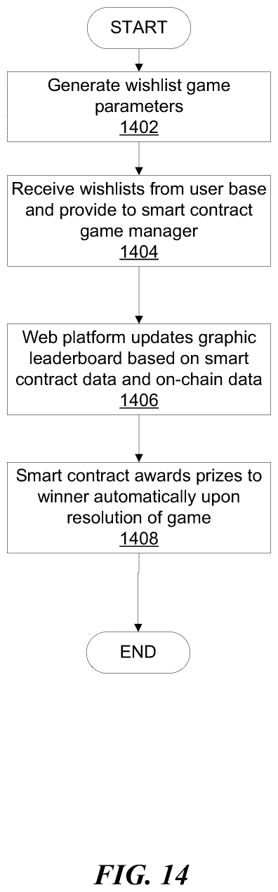

FIG. 14 is a flowchart illustrating a schema associated with a wishlist game. In step 1402, a wishlist game is generated having a set of parameters dictated by a smart contract. the smart contract includes a list of parameters the game follows and rules to execute. Access to the smart contract is limited to a web platform. Game actions taken by players are facilitated and communicated to the smart contract through the web platform. Arbitration of game rules and player entries are dictated by the smart contract and not the web platform. The web platform may be described as a host for the smart contract game.

The game described herein is a wishlist game; however, other games are facilitated in the same fashion by which a smart contract game manager is hosted by a web platform that receives and delivers player input, but the smart contract dictates the operation of the game. The smart contract game manager decentralizes the creation and management of the game from the facilitation of the game. Such an arrangement enables the web platform to be the host of the game created/sponsored by another party.

In step 1404, a user links a wishlist to a wishlist game. A wishlist herein is a list of unique cryptographic objects (e.g., NFTs) belonging to one or more collections. The path to linking wishlists to the game varies by embodiment and game settings. The player instructions are received via the web platform, but the nature of those instructions varies by circumstance. In some circumstances, the user must have a cryptographic wallet linked to the social network/web platform that facilitates the execution of the game. In other circumstances, users are able to engage with the wishlist game without a sign-up process. In some circumstances the wishlists are created/populated by the users upon joining the game, whereas some wishlists are previously generated/populated and linked to the game at a request. In some circumstances, the wishlist is the set of cryptographic objects owned by the user in their linked wallet. In some wishlist game settings, the wishlists are verified based on on-chain criteria that is validated by the smart contract that governs the game.

In step 1406, the game runs for a predetermined period and a leaderboard updates based on the status during the game. The web platform presents game data in a graphic format to users using art assets that are available on the web platform and technical data from the smart contract that governs the game. In some embodiments the web platform further draws technical data from on-chain data that is not necessarily part of the smart contract. The technical data (e.g., rules of the game and/or transactions occurring on cryptographic assets on wishlists or in collections that are represented on wishlists). On-chain data refers to data represented on a distributed blockchain structure and, based on the smart contract governing the game and/or content of wishlists, may include numerous blockchain data structures. The leaderboard includes graphic elements of individual users and the graphic elements representing those users are shifted based on the on-chain data using governance from the smart contract.

In step 1408, at the end of the predetermined period, the smart contract determines a winner of the game and automatically awards prizes based on entries. Entires comprise cryptographic wallets. Where the user has linked a wallet to the web platform, the user's wallet is entered into the smart contract that governs the game. Where the user did not provide a wallet, the web platform enters a proxy wallet for the user. The user may collect prizes from the web platform using whatever identifying information they have provided to the web platform to generate an entry.

### Computing Platform

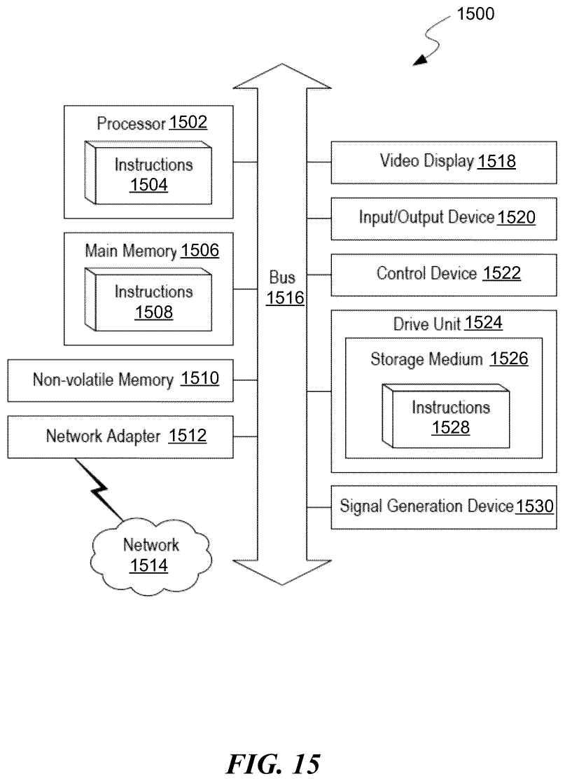

FIG. 15 is a block diagram illustrating an example computer system 1500, in accordance with one or more embodiments. In some embodiments, components of the example computer system 1500 are used to implement the software platforms described herein. At least some operations described herein can be implemented on the computer system 1500.

The computer system 1500 can include one or more central processing units (“processors”) 1502, main memory 1506, non-volatile memory 1510, network adapters 1512 (e.g., network interface), video displays 1518, input/output devices 1520, control devices 1522 (e.g., keyboard and pointing devices), drive units 1524 including a storage medium 1526, and a signal generation device 1520 that are communicatively connected to a bus 1516. The bus 1516 is illustrated as an abstraction that represents one or more physical buses and/or point-to-point connections that are connected by appropriate bridges, adapters, or controllers. The bus 1516, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The computer system 1500 can share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1500.

While the main memory 1506, non-volatile memory 1510, and storage medium 1526 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 1528. The term “machine-readable medium” and “storage medium” shall also be taken to include any medium that is capable of storing, encoding, or carrying a set of instructions for execution by the computer system 1500. In some embodiments, the non-volatile memory 1510 or the storage medium 1526 is a non-transitory, computer-readable storage medium storing computer instructions, which can be executed by the one or more central processing units (“processors”) 1502 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1504, 1508, 1528) set at various times in various memory and storage devices in a computer device. When read and executed by the one or more processors 1502, the instruction(s) cause the computer system 1500 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1510, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 1512 enables the computer system 1500 to mediate data in a network 1514 with an entity that is external to the computer system 1500 through any communication protocol supported by the computer system 1500 and the external entity. The network adapter 1512 can include a network adapter card, a wireless network interface card, a router, an access point, a wireless router, a switch, a multilayer switch, a protocol converter, a gateway, a bridge, a bridge router, a hub, a digital media receiver, and/or a repeater.

The network adapter 1512 can include a firewall that governs and/or manages permission to access proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

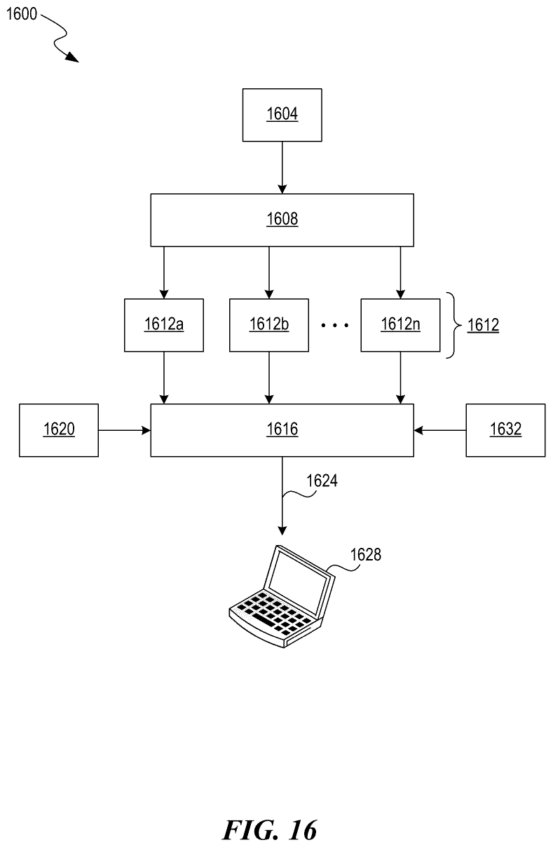

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 1600 illustrated and described in more detail with reference to FIG. 16.

### Machine Learning System

FIG. 16 is a block diagram illustrating an example ML system 1600, in accordance with one or more embodiments. The ML system 1600 is implemented using components of the example computer system 1600 illustrated and described in more detail with reference to FIG. 15. Likewise, embodiments of the ML system 1600 can include different and/or additional components or be connected in different ways. The ML system 1600 is sometimes referred to as a ML module.

The ML system 1600 includes a feature extraction module 1608 implemented using components of the example computer system 1600 illustrated and described in more detail with reference to FIG. 16. In some embodiments, the feature extraction module 1608 extracts a feature vector 1612 from input data 1604. For example, the input data 1604 can include one or more images, sets of text, audio files, or video files. The feature vector 1612 includes features 1612a, 1612b, . . . 1612n. The feature extraction module 1608 reduces the redundancy in the input data 1604, e.g., repetitive data values, to transform the input data 1604 into the reduced set of features 1612, e.g., features 1612a, 1612b, . . . 1612n. The feature vector 1612 contains the relevant information from the input data 1604, such that events or data value thresholds of interest can be identified by the ML model 1616 by using this reduced representation. In some example embodiments, dimensionality reduction techniques, such as principal component analysis (PCA) or autoencoders are used by the feature extraction module 1608.

In alternate embodiments, the ML model 1616 performs deep learning (also known as deep structured learning or hierarchical learning) directly on the input data 1604 to learn data representations, as opposed to using task-specific algorithms. In deep learning, no explicit feature extraction is performed; the features 1612 are implicitly extracted by the ML system 1600. For example, the ML model 1616 can use a cascade of multiple layers of nonlinear processing units for implicit feature extraction and transformation. Each successive layer uses the output from the previous layer as input. The ML model 1616 can learn in supervised (e.g., classification) and/or unsupervised (e.g., pattern analysis) modes. The ML model 1616 can learn multiple levels of representations that correspond to different levels of abstraction, wherein the different levels form a hierarchy of concepts. In this manner, the ML model 1616 can be configured to differentiate features of interest from background features.

In alternative example embodiments, the ML model 1616, e.g., in the form of a CNN generates the output 1624, without the need for feature extraction, directly from the input data 1604. The output 1624 is provided to the computer device 1628. The computer device 1628 is a server, computer, tablet, smartphone, smart speaker, etc., implemented using components of the example computer system 1500 illustrated and described in more detail with reference to FIG. 15. In some embodiments, the steps performed by the ML system 1600 are stored in memory on the computer device 1628 for execution. In other embodiments, the output 1624 is displayed on high-definition monitors.

A CNN is a type of feed-forward artificial neural network in which the connectivity pattern between its neurons is inspired by the organization of a visual cortex. Individual cortical neurons respond to stimuli in a restricted region of space known as the receptive field. The receptive fields of different neurons partially overlap such that they tile the visual field. The response of an individual neuron to stimuli within its receptive field can be approximated mathematically by a convolution operation. CNNs are based on biological processes and are variations of multilayer perceptrons designed to use minimal amounts of preprocessing.

The ML model 1616 can be a CNN that includes both convolutional layers and max pooling layers. The architecture of the ML model 1616 can be “fully convolutional,” which means that variable sized sensor data vectors can be fed into it. For all convolutional layers, the ML model 1616 can specify a kernel size, a stride of the convolution, and an amount of zero padding applied to the input of that layer. For the pooling layers, the ML model 1616 can specify the kernel size and stride of the pooling.

In some embodiments, the ML system 1600 trains the ML model 1616, based on the training data 1620, to correlate the feature vector 1612 to expected outputs in the training data 1620. As part of the training of the ML model 1616, the ML system 1600 forms a training set of features and training labels by identifying a positive training set of features that have been determined to have a desired property in question and a negative training set of features that lack the property in question. The ML system 1600 applies ML techniques to train the ML model 1616, that when applied to the feature vector 1612, outputs indications of whether the feature vector 1612 has an associated desired property or properties.

The ML system 1600 can use supervised ML to train the ML model 1516, with features from the training sets serving as the inputs. In some embodiments, different ML techniques, such as support vector machine (SVM), regression, naïve Bayes, random forests, neural networks, etc., are used. In some example embodiments, a validation set 1632 is formed of additional features, other than those in the training data 1620, which have already been determined to have or to lack the property in question. The ML system 1600 applies the trained ML model 1616 to the features of the validation set 1632 to quantify the accuracy of the ML model 1616. In some embodiments, the ML system 1600 iteratively re-trains the ML model 1616 until the occurrence of a stopping condition, such as the accuracy measurement indication that the ML model 1616 is sufficiently accurate, or a number of training rounds having taken place.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

1. A method of management of a social media leaderboard based on a grouping floor of interrelated digital objects, wherein each digital object belongs to a group of the interrelated digital objects comprising:
identifying, via inspection of cryptographic records on a distributed blockchain, groups of interrelated digital objects that include a similar point of origin indicated by the cryptographic records;
continuously determining for a predetermined period, via inspection of the cryptographic records on the distributed blockchain, a value associated with a lowest valued individual digital object in a given group of interrelated digital objects, wherein both the value and the lowest valued individual digital object are variable over the predetermined period;
in response to said continuously determining, attributing the value associated with the lowest valued individual digital object of the given group of interrelated digital objects to the entire given group of interrelated digital objects as a floor-value of the given group of interrelated digital objects;
linking, a plurality of users, to respective lists of groups of the interrelated digital objects, wherein each group of the interrelated digital objects in the respective lists has an associated quantity within the respective lists;
ranking the plurality of users based on the respective lists of the interrelated digital objects linked thereto, wherein said ranking is based on a respective floor-value of each the groups in the respective lists and the associated quantity wherein a higher position on the social media leaderboard corresponds to a higher value of respective list of groups; and
displaying the social media leaderboard on a graphical webpage presentation with a live updating interface for the predetermined period based on the continuously determining, the graphical webpage presentation including graphic elements of individual users that are shifted based on the on-chain data using governance from a smart contract deployed on the distributed blockchain.

2. The method of claim 1, further comprising:
receiving a first list of groups of the interrelated digital objects from a first user.

3. The method of claim 2, wherein the first list of groups of the interrelated digital objects is populated by at least one user selection.

4. The method of claim 2, wherein the first list of groups of the interrelated digital objects is populated by at least one random selection by a social media platform.

5. The method of claim 2, wherein the first list of groups of the interrelated digital objects is populated by at least one digital object linked to a digital wallet associated with a social media profile of the first user.

6. (canceled)

7. The method of claim 1, further comprising:
Periodically scraping a published web database to obtain a current status associated with respective lists of groups of the interrelated digital objects; and
updating the live updating interface based on the periodically scraping.

8. A system of management of a social media leaderboard based on a grouping floor of digital objects, wherein each digital object belongs to a collection of digital objects comprising:
a processor; and
a memory including instructions that when executed cause the processor to:
identify, via inspection of cryptographic records on a distributed blockchain, collections of interrelated digital objects that include a similar point of origin indicated by the cryptographic records;
continuously determine for a predetermined period, via inspection of the cryptographic records on the distributed blockchain, a value associated with a lowest valued individual digital object in a given collection of interrelated digital objects, wherein both the value and the lowest valued individual digital object are variable over the predetermined period;
in response to said continuously determining, attribute the value associated with the lowest valued individual digital object of the given collection of interrelated digital objects to the entire given collection of interrelated digital objects as a floor-value of the given collection of interrelated digital objects;
link, a user, to a first list of collections of interrelated digital objects, wherein each collection of interrelated digital objects in the first list has an associated quantity;
rank the user among other users based on the first list as compared to lists of other users, wherein said ranking is based on a respective floor value of each the collections in the first list and the associated quantity wherein a higher position on the social media leaderboard corresponds to a higher value of list; and
display the social media leaderboard on a graphical webpage presentation with a live updating interface for the predetermined period based on the continuously determining, the graphical webpage presentation including graphic elements of individual users that are shifted based on the on-chain data using governance from a smart contract deployed on the distributed blockchain.

9. The system of claim 8, the instructions further comprising:
Receiving the first list of collections of the interrelated digital objects from the user.

10. The system of claim 9, wherein the first list of collections of the interrelated digital objects is populated by at least one user selection.

11. The system of claim 9, wherein the first list of collections of the interrelated digital objects is populated by at least one random selection by a social media platform.

12. The system of claim 9, wherein the first list of collections of the interrelated digital objects is populated by at least one digital object linked to a digital wallet associated with a social media profile of the user.

13. (canceled)

14. The system of claim 8, the instructions further comprising:
Periodically scraping a published web database to obtain a current status associated with the first list of collections of the interrelated digital objects; and
updating the live updating interface based on the periodically scraping.

15. A non-transitory computer-readable medium of management of a social media leaderboard based on a grouping floor of digital objects, wherein each digital object belongs to a collection of digital objects, the computer-readable medium contains a plurality of instructions that when executed by a processor cause the processor to:
identify, via inspection of cryptographic records on a distributed blockchain, collections of interrelated digital objects that include a similar point of origin indicated by the cryptographic records;
continuously determine for a predetermined period, via inspection of the cryptographic records on the distributed blockchain, a value associated with a lowest valued individual digital object in a given collection of interrelated digital objects, wherein both the value and the lowest valued individual digital object are variable over the predetermined period;
in response to said continuously determining, attribute the value associated with the lowest valued individual digital object of the given collection of interrelated digital objects to the entire given collection of interrelated digital objects as a floor-value of the given collection of interrelated digital objects;
link, a user, to a first list of collections of digital objects, wherein each collection of interrelated digital objects in the first list has an associated quantity;
rank the user among other users based on the first list as compared to lists of other users, wherein said ranking is based on a respective floor value of each the collections in the first list and the associated quantity wherein a higher position on the social media leaderboard corresponds to a higher value of list; and
display the social media leaderboard on a graphical webpage presentation with a live updating interface for the predetermined period based on the continuously determining, the graphical webpage presentation including graphic elements of individual users that are shifted based on the on-chain data using governance from a smart contract deployed on the distributed blockchain.

16. The non-transitory computer-readable medium of claim 15, wherein the first list of collections of interrelated digital objects is populated by at least one user selection.

17. The non-transitory computer-readable medium of claim 15, wherein the first list of collections of interrelated digital objects is populated by at least one random selection by a social media platform.

18. The non-transitory computer-readable medium of claim 15, wherein the first list of collections of interrelated digital objects is populated by at least one digital object linked to a digital wallet associated with a social media profile of the user.

19. (canceled)

20. The non-transitory computer-readable medium of claim 15, the instructions further comprising:
periodically scraping a published web database to obtain a current status associated with the first list of collections of interrelated digital objects; and
updating the live updating interface based on the periodically scraping.
